(19) United States
(12) Patent Application Publication
(10) Pub. No.: US 2024/0388929 A1
(43) Pub. Date: Nov. 21, 2024

(54) WIRELESS MAJORITY VOTE COMPUTATION WITH COMPLEMENTARY SEQUENCES FOR DISTRIBUTED GUIDANCE

(71) Applicant: UNIVERSITY OF SOUTH CAROLINA, COLUMBIA, SC (US)

(72) Inventors: ALPHAN SAHIN, COLUMBIA, SC (US); XIAOFENG WANG, IRMO, SC (US)

(21) Appl. No.: 18/648,829

(22) Filed: Apr. 29, 2024

Related U.S. Application Data
(60) Provisional application No. 63/560,258, filed on Mar. 1, 2024.
(60) Provisional application No. 63/503,243, filed on May 19, 2023.

(51) Int. Cl. H04W 24/02; H04B 7/06; H04W 84/06

(52) U.S. Cl. CPC H04W 24/02; H04B 7/0626; H04W 84/06

(57) ABSTRACT

The disclosure relates to methodology and apparatus for a non-coherent over-the-air computation (OAC) methodology to calculate the majority vote (MV) reliably in fading channel. The disclosed approach relies on modulating the amplitude of the elements of complementary sequences (CSs) based on the sign of the parameters to be aggregated. Since the disclosed method does not use channel state information at the nodes, it is compatible with time-varying channels. The methodology is useful for an unmanned aerial vehicle (UAV) guided by distributed sensors based on the MV computed with the method. The method improves the computation error rate with a longer sequence length in fading channel while maintaining the peak-to-mean-envelope power ratio of the transmitted orthogonal frequency division multiplexing signals to be less than or equal to 3 dB.

### PRIORITY CLAIM

The present application claims the benefit of priority of U.S. Provisional Patent Application No. 63/503,243, filed May 19, 2023, and the benefit of priority of U.S. Provisional Patent Application No. 63/560,258, filed Mar. 1, 2024, both of which are titled Wireless Majority Vote Computation With Complementary Sequences For Distributed Guidance, and both of which are fully incorporated herein by reference and for all purposes.

### BACKGROUND OF THE PRESENTLY DISCLOSED SUBJECT MATTER

The present disclosure generally relates to methodology and apparatus for complementary sequences, orthogonal frequency-division multiple (OFDM) access, over-the-air computation (OAC), power amplifier non-linearity, and/or wireless federated learning subject matter.

### I. Introduction

Multi-user interference is often considered an undesired situation as it can degrade the performance of communications. In contrast, the same underlying phenomenon, i.e., the signal superposition property of wireless multiple-access channels, can be very useful in the computation of special mathematical functions, i.e., the family of nomographic functions such as mean, norm, polynomial function, maximum, and majority vote (MV) [1]. The gain obtained with over-the-air computation (OAC) is that the resource usage can be reduced to a one-time cost, which otherwise scales with the number of nodes [2]. Hence, OAC can benefit applications when a large number of nodes participate in computation over a bandwidth-limited wireless channel.

OAC was first analyzed by Bobak and Gastpar [3] and applied to communication problems under interference channels and wireless sensor networks to improve spectrum utilization [4]. Recently, it has gained momentum for computation-oriented applications over wireless networks such as wireless federated learning or wireless control systems. For example, the authors in [5]-[8] implement federated learning (FL) [9] over a wireless network, where OAC is used for aggregating gradients or model parameters of neural networks. In [10], difference equations are proposed to be computed with OAC. In [11], dynamic plants are considered along with OAC. In [12], OAC is utilized to achieve mean consensus for vehicle platooning. In [13], multi-slot coherent OAC is investigated for an unmanned aerial vehicle (UAV) network, where the UAV s compute the arithmetic mean of ground sensor readings with OAC. Similarly, in [14], UAV trajectories are optimized based on the locations of the sensors.

However, a major difficulty for OAC is computing functions in fading channels, or, stated more particularly, computing functions in time-varying fading channels under power amplifier non-linearity.

To overcome fading channels, a large number of studies adopt pre-equalization techniques where the parameters are distorted with the reciprocals of the channel coefficients before the transmission so that the transmitted signals superpose coherently at the receiver [7], [8], [15]. Although this approach has its merit, it requires precise sample-level time synchronization as coherent signal superposition is sensitive to phase synchronization errors. Another issue is that OAC waveforms can have a high peak-to-average-power ratio and cause spectral growth, i.e., interference to adjacent channels in the RF spectrum.

Also, in [16], it is shown that non-stationary channel conditions particularly in a UAV network can severely degrade the coherent signal superposition. To relax this bottleneck, another approach is to use non-coherent techniques at the expense of sacrificing more resources. For instance, in [6] and [17], orthogonal resources are allocated and energy accumulation on the resources are used for OAC. In [18], random sequences are proposed to be utilized for OAC and the energy of the superposed sequences is calculated at the expense of interference components.

A major challenge with non-coherent OAC is that the reliability cannot be improved directly by increasing the signal power due to the lack of pre-equalization. Hence, non-coherent OAC requires more investigations for reducing computation errors.

### SUMMARY OF THE PRESENTLY DISCLOSED SUBJECT MATTTER

The presently disclosed methodologies and corresponding and/or associated systems, including in some instances computer systems, generally relates to over-the-air computation (OAC) methodologies. More particularly, presently disclosed subject matter relates to non-coherent over-the-air computation (OAC) methodologies to calculate the majority vote (MV) reliably in fading channel.

In some instances, presently disclosed embodiments relate to methodology and apparatus for complementary sequences, orthogonal frequency-division multiple (OFDM) access, over-the-air computation (OAC), power amplifier non-linearity, and wireless federated learning subject matter.

The presently disclosed subject matter in some instances relies on modulating the amplitude of the elements of complementary sequences (CSs) based on the sign of the parameters to be aggregated. For presently disclosed embodiments not using channel state information at the nodes, they are compatible with time-varying channels.

For some particular embodiments, we show the efficacy of the presently disclosed subject matter for use in a scenario where an unmanned aerial vehicle (UAV) is guided by distributed sensors based on the MV computed with the disclosed methodology subject matter. For example, some embodiments may relate to majority vote computation with complementary sequences for distributed UAV guidance.

For some instances, we show that the disclosed subject matter improves the computation error rate with a longer sequence length in fading channel while maintaining the peak-to-mean-envelope power ratio of the transmitted orthogonal frequency division multiplexing signals to be less than or equal to 3 dB.

In some presently disclosed embodiments for addressing the difficulty that OAC is computing functions in time-varying fading channels under power amplifier non-linearity, the presently discloses non-coherent OAC methodology is based on complementary sequences (CSs). The disclosed approach improves the robustness of computation against fading channels while limiting the dynamic range of transmitted signals to mitigate the distortion, like clipping, due to hardware non-linearity. Since the disclosed approach does not rely on the availability of channel state information (CSI) at the transmitter and receiver, it also provides robustness against time-varying channels.

The market size for applications for the presently disclosed subject matter is relatively large as it is related to commercial wireless, control, and AI technologies. It could be useful, for example, for distributed control systems, massive numbers of robots, artificial intelligence technologies over wireless or sensor networks, 5G and beyond, 6G wireless standardization, and IEEE 802.11 Wi-Fi.

Potential competitive advantages of embodiments of presently disclosed subject matter may be several, including, for example, (1) reliable computation via bandwidth expansion without using the channel state information at the nodes, (2) low peak-to-mean-envelope-power ratio (maximum is 3 dB) to improve power efficiency (i.e., improved battery life or link distance), and (3) improved latency by computing via signal superposition.

Other example aspects of the present disclosure are directed to systems, apparatus, tangible, non-transitory computer-readable media, user interfaces, memory devices, and electronic devices for over-the-air computation (OAC) technology. To implement such systems, and methodology and technology herewith, one or more processors may be provided, programmed to perform the steps and functions as called for by the presently disclosed subject matter, as will be understood by those of ordinary skill in the art.

One exemplary embodiment disclosed herewith relates to an over-the-air computation (OAC) system for computation-oriented federated applications over wireless networks having a plurality of nodes. Such exemplary system preferably comprises one or more processors; and one or more non-transitory computer-readable media that store instructions that, when executed by the one or more processors, cause the one or more processors to perform operations. Such operations preferably comprise: transmitting local update vectors as votes from each respective of the plurality of nodes via a wireless multiple access channel, receiving the superposed local updates at at least one of the plurality of nodes, and determining the majority vote (MV) for each element of the update vector at the at least one node by non-coherent over-the-air computation (OAC) methodology to calculate the majority vote (MV) reliably in fading channels.

It is to be understood that the presently disclosed subject matter equally relates to associated and/or corresponding methodologies.

Another exemplary embodiment of presently disclosed subject matter relates to over-the-air computation (OAC) methodology for use on computation-oriented federated applications over wireless networks having a plurality of nodes. Such exemplary methodology preferably comprises providing one or more processors; and providing one or more non-transitory computer-readable media that store instructions that, when executed by the one or more processors, cause the one or more processors to perform operations. Such operations preferably comprise: transmitting local update vectors as votes from each respective of the plurality of nodes via a wireless multiple access channel, receiving the superposed local updates at at least one of the plurality of nodes, and determining the majority vote (MV) for each element of the update vector at the at least one node by non-coherent over-the-air computation (OAC) methodology to calculate the majority vote (MV) reliably in fading channels.

Additional objects and advantages of the presently disclosed subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments, uses, and practices of the presently disclosed subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the presently disclosed subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the presently disclosed subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification, and will appreciate that the presently disclosed subject matter applies equally to corresponding methodologies as associated with practice of any of the present exemplary devices, and vice versa.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a Table (TABLE 1), which is an example of encoded complementary sequences (CSs) based on votes for m=3;

FIGS. 2(a) through 2(d) graphically provide the peak-to-mean envelope power ratio (PMEPR) distribution and the computation error rate (CER) for a given {p, q, z}, where p, q, and z denote the probabilities Pr (v_{k,n}>0), Pr (v_{k,n}<0), and Pr (v_{k,n}=0), respectively, for K=50 sensors, with specifically FIG. 2(a) graphically providing PMEPR distribution for m=8, p=0.1 and z∈{0.1, 0.3, 0.6}, and with specifically FIGS. 2(b), 2(c), and 2(d) graphically providing results of analyzing CER for z∈{0.1, 0.6} and m={2, 4, 6, 8} by sweeping p in additive white Gaussian noise (AWGN) (i.e., h_{k,i}=1)(FIG. 2(b)), flat-fading (i.e., h_{k,i}=h_{k,i′}˜CN(0, 1))(FIG. 2(c), and frequency-selective (i.e., h_{k,i}˜CN(0, 1))(FIG. 2(d)) channels, respectively;

FIGS. 3(a) and 3(b) graphically illustrate, respectively, an exemplary UAV's trajectory in time (FIG. 3(a)) and in space (FIG. 3(b)), based on a UAV's trajectory with a single point of interest, where the initial position is (pi,1, pi,2, pi,3)=(0, 0, 0) and the target is (pt,1, pt,2, pt,3)=(10, 8, 6); and

FIGS. 4(a) and 4(b) graphically illustrate, respectively, an exemplary UAV's trajectory in time (FIG. 4(a)) and in space (FIG. 4(b)), based on a UAV's trajectory with multiple points of interest, where the initial position is (pi,1, pi,2, pi,3)=(1, 1, 0) and the multiple targets are (pt,1, pt,2, pt,3)=(1, 1, 6), (1, 4, 6), (7, 4, 6), and (7, 4, 0).

Repeat use of reference characters in the present specification and drawings is intended to represent the same or analogous features, elements, or steps of the presently disclosed subject matter.

### DETAILED DESCRIPTION OF THE PRESENTLY DISCLOSED SUBJECT MATTER

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the presently disclosed subject matter relates to methodology and apparatus for such as complementary sequences, orthogonal frequency-division multiple (OFDM) access, over-the-air computation (OAC), power amplifier non-linearity, and/or wireless federated learning subject matter.

In the present disclosure, we focus on computing MV which can be made compatible with digital modulation due to its discrete nature, and finds applications such as distributed training [6]-[8] and distributed localization [17]. We presently disclose a new noncoherent OAC methodology based on complementary sequences (CSs) [19] to improve the robustness of computation against fading channels while limiting the dynamic range of transmitted signals to mitigate the distortion, like clipping, due to hardware non-linearity. Since the disclosed approach does not rely on the availability of channel state information (CSI) at the transmitter and receiver, it also provides robustness against time-varying channels.

As opposed to earlier studies in [13], [14], [16], we demonstrate the applicability of the disclosed method to a scenario where, for example, a UAV is guided by distributed sensors based on MV computation.

### II. System Model

Consider a scenario where a UAV flies from one point of interest (p_{i,1}, p_{i,2}, p_{i,3}) to another point of interest (p_{t,1}, p_{t,2}, p_{t,3}) in an indoor environment. Suppose that the UAV cannot localize its location in the room. However, it can receive feedback from K distributed sensors deployed in the room about the velocity of the UAV on x-, y-, and z-axis for every T_{update} seconds. Based on the feedback from the sensors, the UAV updates its position at [symbol] round for the x-axis, y-axis, and z-axis, denoted by [symbol] and [symbol] respectively, as

$$\begin{matrix}{p}_{n}^{( ℓ + 1 )} = {p}_{n}^{( ℓ )} - {T}_{update} {u}_{n}^{( ℓ )} , ∀ n ∈ \{ 1 , 2 , 3 \} , \\ {u}_{n}^{( ℓ )} = \{ \begin{matrix}max \{ μ {g}_{n}^{( ℓ )} , - {u}_{limit} \} & {g}_{n}^{( ℓ )} < 0 \\ min \{ μ {g}_{n}^{( ℓ )} , {u}_{limit} \} & {g}_{n}^{( ℓ )} \geq 0\end{matrix} ,\end{matrix} \qquad ( 1 )$$

where [symbol] is the velocity at the [symbol] round for nth coordinate, uₗᵢₘᵢₜ>0 is the maximum velocity of the UAV, μ>0 is the step size, [symbol] is the velocity-update strategy given by

$$\\ {g}_{n}^{{}_{} ( ℓ )} = \{ \begin{matrix}\frac{1}{K} {\sum }_{k = 1}^{K} \tilde{p} {}_{n , k}^{{}_{} ( ℓ )} - {p}_{t , n} , & Ideal ( Continous ) \\ {ω}_{n} , & Ideal ( MV ) \\ {\hat{ω}}_{n} , & OAC ( MV ) , ( 10 )\end{matrix} ,$$

where [symbol] = [symbol] + [symbol] is the estimated position of the UAV for the nth coordinate at the kth sensor, [symbol] is a zero-mean Gaussian variable with the variance σₛₑₙₛₒᵣ², ωₙ is the ideal MV function expressed as ωn=sign (Σₖ₌₁^{K}v_{k,n}), for v_{k,n}=sign ( [symbol] −p_{t,n}) for n∈{1, 2, 3} and \hat{ω}ₙ denotes the MV obtained with the presently disclosed OAC methodology.

### A. Complementary Sequences

Let a=(aᵢ)ᵢ₌₀^{L-1}™(a₀, a₁, . . . , a_{L-1}) be a sequence of length L for aᵢ∈ [symbol] and a_{L-1}≠0. We associate the sequence a with the polynomial A(z)=a_{L-1}z^{L}^{^{−1}}+a_{L-2}z^{L}^{^{−2}}+ . . . +a₀ in indeterminate z. The aperiodic auto-correlation function (AACF) of the sequence a given by

$$\\ \begin{matrix}{ρ}_{a} ( k ) {=}^{△} \{ \begin{matrix}{\sum }_{i = 0}^{L - k - 1} {a}_{i}^{{}_{} *} {a}_{i + k} , & 0 \leq k \leq L - 1 \\ {\sum }_{i = 0}^{L + k - 1} {a}_{i} {a}_{i - k}^{{}_{} *} , & - L + 1 \leq k < 0 \\ 0 , & otherwise\end{matrix} . & ( 2 )\end{matrix}$$

If ρₐ(k)+ρ_{b}(k)=0 holds for k≠0, the sequences a and b are referred to as CSs. It can be shown the peak-to-mean envelope power ratio (PMEPR) of an orthogonal frequency division multiplexing (OFDM) symbol constructed based on a CS is less than or equal to 3 dB [20].

Let f(x) be a map from [symbol] ₂^{m}={x≙(x₁, x₂, . . . , xₘ)|∀xⱼ∈ [symbol] ₂} to [symbol] as f: [symbol] ₂^{m}→ [symbol] , i.e., a pseudo-Boolean function. CSs can be obtained via pseudo-Boolean functions as follows:

Theorem 1 ([19]). Let π=(πₙ)ₙ₌₁^{m} be a permutation of {1, 2, . . . , m}. For any H, m∈ [symbol] ⁺, aₙ, a′∈ [symbol] , and cₙ, c′∈ [symbol] _{H} for n∈{1, 2, . . . , m}, let

$$\\ \begin{matrix}{f}_{r} ( x ) = {\sum }_{n = 1}^{m} {a}_{n} {y}_{{π}_{n}} + {a}^{{}_{} ′} , & ( 3 )\end{matrix}$$

$$\\ \begin{matrix}{f}_{i} ( x ) = \frac{H}{2} {\sum }_{n = 1}^{m - 1} {x}_{{π}_{n}} {x}_{{π}_{n + 1}} + {\sum }_{n = 1}^{m} {c}_{n} {x}_{{π}_{n}} + {c}^{{}_{} ′} , & ( 4 )\end{matrix}$$

where y_{π}_{ₙ} is (x_{π}_{ₙ}+x_{π}_{ₙ₊₁})₂ and x_{π}_{ₘ} for n<m and n=m, respectively. Then, the sequence t=(t₀, . . . , t_{L-1}), where its associated polynomial is given by

$$\\ \begin{matrix}T ( 𝓏 ) = {\sum }_{∀ x ∈ {ℤ}_{2}^{{}_{} m}} {\underbrace{{e}^{{}_{} {f}_{r} ( x )} {e}^{{}_{} j \frac{2 π}{H} {f}_{i} ( x )}}}_{{t}_{i ( x )}} {}_{} {𝓏}^{{}_{} i ( x )} , & ( 5 )\end{matrix}$$

is a CS of length L=2^{m}, where i(x) [symbol] Σⱼ₌₁^{m}xⱼ2^{m-j}, i.e., a decimal representation of the binary number constructed using all elements in the sequence x.

Theorem 1 shows that the functions that determine the amplitude and the phase of the elements of the CS t(i.e., fᵢ(x) and fᵢ(x)) and Reed-Muller (RM) codes have similar structures. The function fᵢ(x) is in the form of the cosets of the first-order RM code within the second-order RM code [20]. Notice that the mapping between {(y₁, . . . , yₘ)} and {(x₁, . . . , xₘ)} is bijective and results in a Gray code when the elements of the set {(x₁, . . . , xₘ)} is ordered lexicographically [19]. Hence, the function fᵣ(x) is also similar to the first-order RM code, except that the operations occur in [symbol] .

### B. Signal Model and Wireless Channel

We assume that the sensors and the UAV are equipped with a single antenna. Let tₖ=(t_{k,0}, . . . , t_{k,L-1}) be a CS of length L transmitted from the kth sensor over an OFDM symbol by mapping its elements to a set of contiguous subcarriers. Assuming that all sensors access the wireless channel simultaneously and the cyclic prefix (CP) duration is larger than the sum of maximum time-synchronization error and maximum-excess delay of the channel, we can express the polynomial representation of the received sequence r=(r₀, . . . , r_{L-1}) at the UAV after the signal superposition as

$$\\ \begin{matrix}R ( 𝓏 ) = {\sum }_{i = 0}^{L - 1} {\underbrace{( {\sum }_{k = 1}^{K} {h}_{k , i} \sqrt{{P}_{k}} {t}_{k , i} + {w}_{i} )}}_{{r}_{i}} {}_{} {𝓏}^{{}_{} i} , & ( 6 )\end{matrix}$$

where h_{k,i}˜CN(0, 1) is the Rayleigh fading channel coefficient between the UAV and the kth sensor for the ith element of the sequence unless otherwise stated, Pₖ is the average transmit power, and wᵢ˜CN(0, σₙₒᵢₛₑ²) is the additive white Gaussian noise (AWGN). We assume that the average received signal powers of the sensors at the UAV are aligned with a power control mechanism. Without loss of generality, we set Pₖ, ∀k, to 1 Watt and calculate the signal-to-noise ratio (SNR) of a sensor at the UAV receiver as SNR=1/σₙₒᵢₛₑ².

### C. Problem Statement

Suppose that the fading coefficient h_{k,i} is not available at the kth sensor or the UAV due to the synchronization impairments, reciprocity calibration errors, or mobility. Under this constraint, for n∈{1, . . . , m}, the main objective of the UAV is to compute the MV ωₙ, ∀n by exploiting the signal superposition property of the multiple-access channel (MAC), where v_{k,n}∈{−1, 0, 1} is the kth sensor's vote for the nth MV computation and ωₙ∈{−1, 1} is the nth MV. It is worth emphasizing that the kth sensor does not participate in the MV computation for v_{k,n}=0. Since we consider a single UAV in this disclosure, we set v_{k,n}=0 for n∈{3, 4, . . . , m}. Note that, in the literature, it is shown that such absentee votes can be useful for distributed training for addressing heterogeneous data distribution [6].

Our main goal is to obtain a methodology that computes the MV s with a low computation error rate (CER) while maintaining the PMEPR of the transmitted signals as low as possible, where we define the CER as the probability of incorrect detection of the nth MV as Pr (\hat{ω}ₙ≠ωₙ). Although the CSs generated with Theorem 1 can address the PMEPR challenge by keeping it at most 3 dB, it is not trivial to use them for the MV computation. Therefore, the question that we address is how can we use Theorem 1 to develop a reliable OAC methodology for computing MV without using the CSI at the sensors and the UAV?

### III. Disclosed Methodology

The disclosed methodology modulates the amplitude of the elements of the CS via fᵣ(x) as a function of the votes vₖ≙(v_{k,1}, . . . , v_{k,m}) at the kth sensor. To this end, based on Theorem 1, let us denote the functions used at kth sensor as f_{r,k} (x) and f_{i,k} (x), and their parameters as {a′ₖ, a_{k,1}, . . . , a_{k,m}} and {c′ₖ, c_{k,1}, . . . , c_{k,m}}, respectively. To synthesize the transmitted sequence tₖ of length L=2^{m}, we use a fixed permutation π and map v_{k,n} to a_{k,n} as

$$\\ \begin{matrix}{a}_{k , n} = \{ \begin{matrix}- α , & {v}_{k , n} = - 1 \\ 0 , & {v}_{k , n} = 0 \\ + α , & {v}_{k , n} = + 1\end{matrix} , ∀ n , & ( 7 )\end{matrix}$$

where α>0 is a scaling parameter. To ensure that the squared [symbol] -norm of the CS tₖ is 2^{m}, i.e., ∥tₖ∥₂²=2^{m}, we choose a′ₖ as

$$\\ \begin{matrix}{a}_{k}^{{}_{} ′} = - \frac{1}{2} {\sum }_{n = 1}^{m} ln \frac{1 + {e}^{{}_{} 2 {a}_{n}}}{2} . & ( 8 )\end{matrix}$$

To derive (8), notice that a_{k,n} scales 2^{m-1} elements of the CS by e^{a}^{_{k,n}}in (3). Therefore, Il all is scaled by (1+e^{2a}^{_{k,n}})/2. By considering a_{k,1}, . . . , a_{k,m}, the total scaling can be calculated as γ=Πₙ₋₁^{m}(1+e^{2a}^{_{k,n}})/2. Thus, e^{2a′}^{ₖ}=1/γ must hold for ∥tₖ∥₂²=2^{m}, which results in (8).

With (7) and (8), if v_{k,n}≠0 for α→∞, one half of elements (i.e., the ones for y_{π}_{ₙ}=0) of the CS tₖ are set to 0 while the other half (i.e., the ones for y_{π}_{ₙ}=1) are scaled by a factor of \sqrt{2} and the sign of v_{k,n} determines which half is amplified. For v_{k,n}=0, the halves are not scaled.

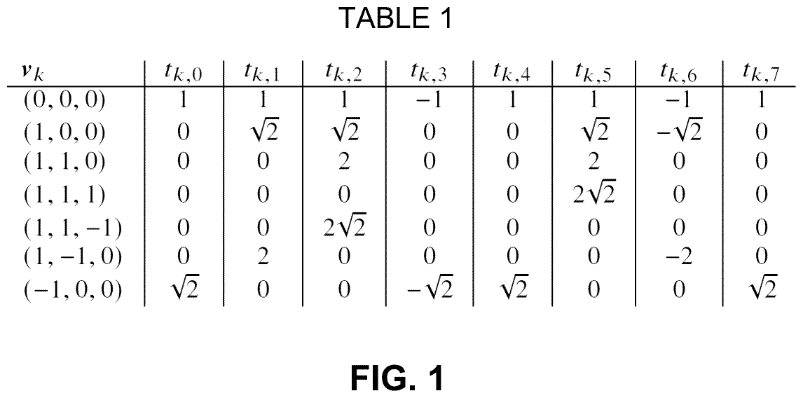

Example 1. Let π=(3, 2, 1), H=2, m=3, cₙ=c′=0, ∀n. Hence, the indices of the scaled elements are controlled by y₁=x₁, y₂=(x₁+x₂)₂, and y₃=(x₂+x₃)₂ when (x₁, x₂, x₃) is listed in lexicographic order, i.e., (0, 0, 0), (0, 0, 1), . . . , (1, 1, 1). FIG. 1 illustrates a Table (TABLE 1), which is an example of encoded complementary sequences (CSs) based on votes for m=3. Stated another way, FIG. 1 (TABLE 1) gives the encoded CSs for several realizations of vₖ for α→∞. For vₖ=(1, 0, 0) and vₖ=(−1, 0, 0), four elements determined by y₃ of the uni-modular CS is scaled by \sqrt{2}, and the rest is multiplied with 0. Similarly, for vₖ=(1, 1, 1) and vₖ=(1, 1, −1), four elements of the CS (i.e., the CS for vk=(1, 1, 0)) is scaled by \sqrt{2}, and the rest is multiplied with 0. It is worth noting that if all the votes are non-zero, only one of the eight elements of the sequence is non-zero.

For the disclosed methodology, the values for c′ₖ, c_{k,1}, . . . , c_{k,m} are chosen randomly from the set [symbol] _{H} for the randomization of tₖ across the sensors. This choice is also in line with the cases where phase synchronization cannot be maintained in the network.

Based on (6), the received sequence at the UAV after signal superposition can be expressed as

$$\\ \begin{matrix}R ( 𝓏 ) = {\sum }_{∀ x ∈ {ℤ}_{2}^{{}_{} m}} {\underbrace{( {\sum }_{k = 1}^{K} {h}_{k , i ( x )} {e}^{{}_{} {f}_{r , k} ( x )} {e}^{{}_{} j \frac{2 π}{H} {f}_{i , k} ( x )} + {w}_{i ( x )} )}}_{{r}_{i ( x )}} {}_{} {𝓏}^{{}_{} i ( x )} , & ( 9 )\end{matrix}$$

To compute the nth MV, the UAV calculates two metrics given by

$$\\ {E}_{n}^{{}_{} +} {=}^{△} {\sum }_{\begin{matrix}∀ x ∈ {ℤ}_{2}^{{}_{} m} \\ {y}_{{π}_{n}} = 1\end{matrix}} {\vert {r}_{i ( x )} \vert}^{2} = {\sum }_{\begin{matrix}∀ x ∈ {ℤ}_{2}^{{}_{} m} \\ {y}_{{π}_{n}} = 1\end{matrix}} {\vert {\sum }_{k = 1}^{K} {h}_{k , i ( x )} {e}^{{}_{} {f}_{r , k} ( x )} {e}^{{}_{} j \frac{2 π}{H} {f}_{i , k} ( x )} + {w}_{i ( x )} \vert}^{2} , and$$

$$\\ {E}_{n}^{{}_{} -} {=}^{△} {\sum }_{\begin{matrix}∀ x ∈ {ℤ}_{2}^{{}_{} m} \\ {y}_{{π}_{n}} = 0\end{matrix}} {\vert {r}_{i ( x )} \vert}^{2} = {\sum }_{\begin{matrix}∀ x ∈ {ℤ}_{2}^{{}_{} m} \\ {y}_{{π}_{n}} = 0\end{matrix}} {\vert {\sum }_{k = 1}^{K} {h}_{k , i ( x )} {e}^{{}_{} {f}_{r , k} ( x )} {e}^{{}_{} j \frac{2 π}{H} {f}_{i , k} ( x )} + {w}_{i ( x )} \vert}^{2} .$$

It then detects the nth MV by comparing the values of Eₙ⁺and Eₙ⁻as

$$\\ \begin{matrix}{\hat{ω}}_{n} = sign ( {E}_{n}^{{}_{} +} - {E}_{n}^{{}_{} -} ) , ∀ n . & ( 10 )\end{matrix}$$

We discuss how (10) allow the UAV to detect the correct MV in the average sense in the following subsection.

### A. How Does It Work Without CSI?

Let K+n, K−n, and K0n be the number of sensors with positive, negative, and zero votes for nth MV computation, respectively.

Lemma 1. [symbol] [Eₙ⁺] and [symbol] [Eₙ⁻] can be calculated as

$$\\ 𝔼 [ {E}_{n}^{{}_{} +} ] = \frac{{2}^{{}_{} m} {e}^{{}_{} 2 α} {K}_{n}^{{}_{} +}}{1 + {e}^{{}_{} 2 α}} + \frac{{2}^{{}_{} m} {e}^{{}_{} - 2 α} {K}_{n}^{{}_{} -}}{1 + {e}^{{}_{} - 2 α}} + {2}^{{}_{} m - 1} ( {K}_{n}^{{}_{} 0} + {σ}_{noise}^{{}_{} 2} ) ,$$

$$\\ 𝔼 [ {E}_{n}^{{}_{} -} ] = \frac{{2}^{{}_{} m} {K}_{n}^{{}_{} +}}{1 + {e}^{{}_{} 2 α}} + \frac{{2}^{{}_{} m} {K}_{n}^{{}_{} -}}{1 + {e}^{{}_{} - 2 α}} + {2}^{{}_{} m - 1} ( {K}_{n}^{{}_{} 0} + {σ}_{noise}^{{}_{} 2} ) ,$$

respectively, where the expectation is over the distribution of channel and noise.

To prove Lemma 1, we first need the following proposition:

Proposition 1. The following identities hold:

$$\\ {\sum }_{\begin{matrix}∀ x ∈ {ℤ}_{2}^{{}_{} m} \\ {y}_{{π}_{n}} = 1\end{matrix}} {e}^{{}_{} 2 {f}_{r , k} ( x )} = {e}^{{}_{} 2 {a}_{k , n}} {\sum }_{\begin{matrix}∀ x ∈ {ℤ}_{2}^{{}_{} m} \\ {y}_{{π}_{n}} = 0\end{matrix}} {e}^{{}_{} 2 {f}_{r , k} ( x )} = \frac{{e}^{{}_{} 2 {a}_{k , n}}}{1 + {e}^{{}_{} 2 {a}_{k , n}}} {2}^{{}_{} m} .$$

Proof of Proposition 1. The first identity is because e^{2a}^{_{k,n}}^{y}^{_{πn}}=1 for y_{π}_{ₙ}=0. With (8), ∥tₖ∥₂²=2^{m} holds. Hence,

$$\\ {‖ {t}_{k} ‖}_{2}^{2} = {\sum }_{∀ x ∈ {ℤ}_{2}^{{}_{} m}} {e}^{{}_{} 2 {f}_{r , k} ( x )} = {\sum }_{\begin{matrix}∀ x ∈ {ℤ}_{2}^{{}_{} m} \\ {y}_{{π}_{n}} = 0\end{matrix}} {e}^{{}_{} 2 {f}_{r , k} ( x )} + {\sum }_{\begin{matrix}∀ x ∈ {ℤ}_{2}^{{}_{} m} \\ {y}_{{π}_{n}} = 1\end{matrix}} {e}^{{}_{} 2 {f}_{r , k} ( x )} = {\sum }_{\begin{matrix}∀ x ∈ {ℤ}_{2}^{{}_{} m} \\ {y}_{{π}_{n}} = 0\end{matrix}} {e}^{{}_{} 2 {f}_{r , k} ( x )} + {e}^{{}_{} 2 {a}_{k , n}} {\sum }_{\begin{matrix}∀ x ∈ {ℤ}_{2}^{{}_{} m} \\ {y}_{{π}_{n}} = 0\end{matrix}} {e}^{{}_{} 2 {f}_{r , k} ( x )} = {2}^{{}_{} m} .$$

Proof of Lemma 1. By using Proposition 1, we can calculate [symbol] [Eₙ⁺] and [symbol] [Eₙ⁻] as

$$\\ 𝔼 [ {E}_{n}^{{}_{} +} ] = {\sum }_{\begin{matrix}∀ x ∈ {ℤ}_{2}^{{}_{} m} \\ {y}_{{π}_{n}} = 1\end{matrix}} 𝔼 [ {\vert {\sum }_{k = 1}^{K} {h}_{k , i ( x )} {e}^{{}_{} {f}_{r , k} ( x )} {e}^{{}_{} j \frac{2 π}{H} {f}_{i , k} ( x )} + {w}_{i ( x )} \vert}^{2} ] = {\sum }_{k = 1}^{K} {\sum }_{\begin{matrix}∀ x ∈ {ℤ}_{2}^{{}_{} m} \\ {y}_{{π}_{n}} = 1\end{matrix}} {e}^{{}_{} 2 {f}_{r , k} ( i )} + {2}^{{}_{} m - 1} {σ}_{noise}^{{}_{} 2} = {2}^{{}_{} m} ( {\sum }_{k = 1}^{K} \frac{{e}^{{}_{} 2 {a}_{k , n}}}{1 + {e}^{{}_{} 2 {a}_{k , n}}} + \frac{{σ}_{noise}^{{}_{} 2}}{2} ) = {2}^{{}_{} m} ( \frac{{e}^{{}_{} 2 α}}{1 + {e}^{{}_{} 2 α}} {K}_{n}^{{}_{} +} + \frac{1}{2} {K}_{n}^{{}_{} 0} + \frac{{e}^{{}_{} - 2 α}}{1 + {e}^{{}_{} - 2 α}} {K}_{n}^{{}_{} -} + \frac{1}{2} {σ}_{noise}^{{}_{} 2} ) , and$$

$$\\ 𝔼 [ {E}_{n}^{{}_{} -} ] = {\sum }_{\begin{matrix}∀ x ∈ {ℤ}_{2}^{{}_{} m} \\ {y}_{{π}_{n}} = 0\end{matrix}} 𝔼 [ {\vert {\sum }_{k = 1}^{K} {h}_{k , i ( x )} {e}^{{}_{} {f}_{r , k} ( x )} {e}^{{}_{} j \frac{2 π}{H} {f}_{i , k} ( x )} + {w}_{i ( x )} \vert}^{2} ] = {\sum }_{k = 1}^{K} {\sum }_{\begin{matrix}∀ x ∈ {ℤ}_{2}^{{}_{} m} \\ {y}_{{π}_{n}} = 0\end{matrix}} {e}^{{}_{} 2 {f}_{r , k} ( i )} + {2}^{{}_{} m - 1} {σ}_{noise}^{{}_{} 2} = {2}^{{}_{} m} ( {\sum }_{k = 1}^{K} \frac{1}{1 + {e}^{{}_{} 2 {a}_{k , n}}} + \frac{{σ}_{noise}^{{}_{} 2}}{2} ) = {2}^{{}_{} m} ( \frac{1}{1 + {e}^{{}_{} 2 α}} {K}_{n}^{{}_{} +} + \frac{1}{2} {K}_{n}^{{}_{} 0} + \frac{1}{1 + {e}^{{}_{} - 2 α}} {K}_{n}^{{}_{} -} + \frac{1}{2} {σ}_{noise}^{{}_{} 2} ) .$$

Without any concern about the norm of the transmitted sequence tₖ with (8), we can choose an arbitrarily large value for α. We can then use the following corollary:

$$\\ {lim}_{α \to ∞} 𝔼 [ {E}_{n}^{{}_{} +} ] = {2}^{{}_{} m} {K}_{n}^{{}_{} +} + {2}^{{}_{} m - 1} {K}_{n}^{{}_{} 0} + {2}^{{}_{} m - 1} {σ}_{noise}^{{}_{} 2} ,$$

$$\\ {lim}_{α \to ∞} 𝔼 [ {E}_{n}^{{}_{} -} ] = {2}^{{}_{} m} {K}_{n}^{{}_{} -} + {2}^{{}_{} m - 1} {K}_{n}^{{}_{} 0} + {2}^{{}_{} m - 1} {σ}_{noise}^{{}_{} 2} .$$

Since lim_{α→∞} [symbol] [Eₙ⁺−Eₙ⁻]=2^{m-1}(Kₙ⁺−Kₙ⁻) holds, we can infer that the detector in (10) detects the correct MV in average for α→∞. In other words, although the disclosed methodology makes errors instantaneously, in average, the error is centered around the correct MV.

The disclosed methodology computes m MVs over 2^{m} complex-valued resources. Hence, the number of functions computed per channel use (in real dimension) can be expressed as [symbol] =m/2^{m+1}. Hence, for a larger m, the computation rate reduces, but the CER improves significantly as demonstrated in Section IV.

### IV. Numerical Results

In this section, we first analyze the performance of the methodology for an arbitrary application. Subsequently, we then apply it to the scenario discussed in Section II.

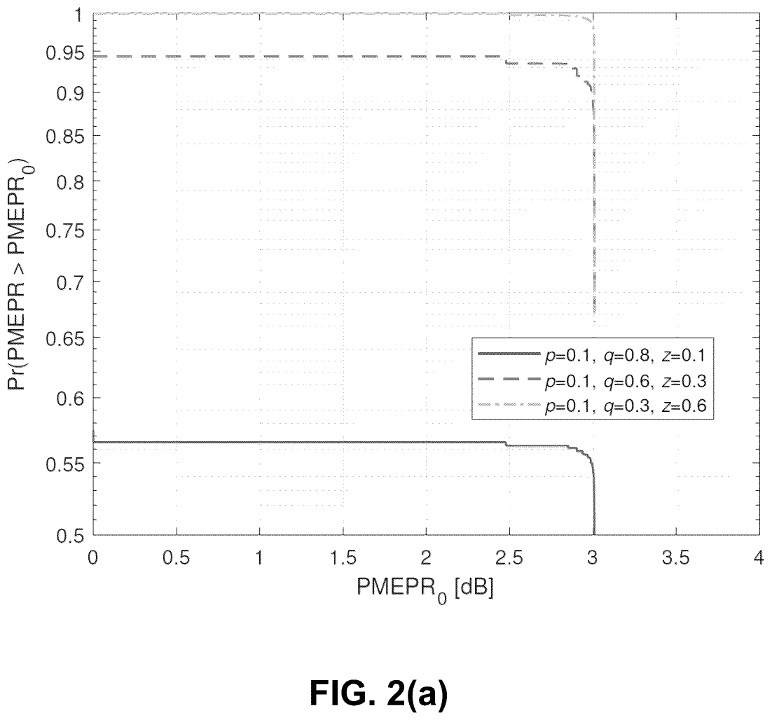

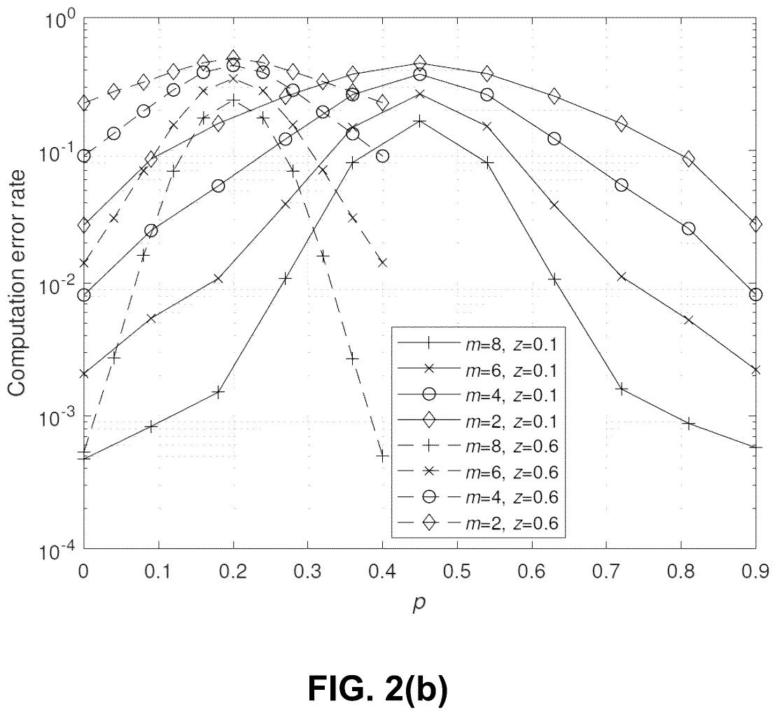

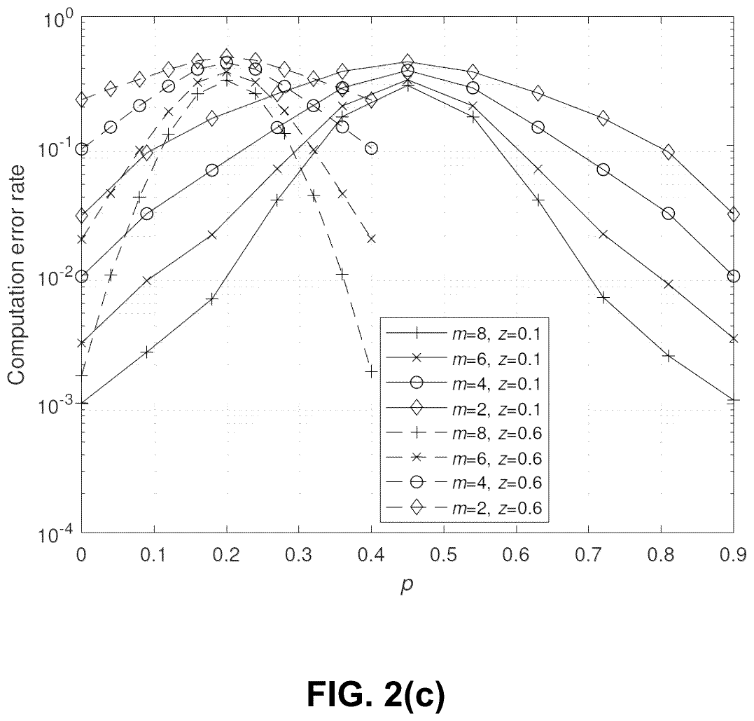

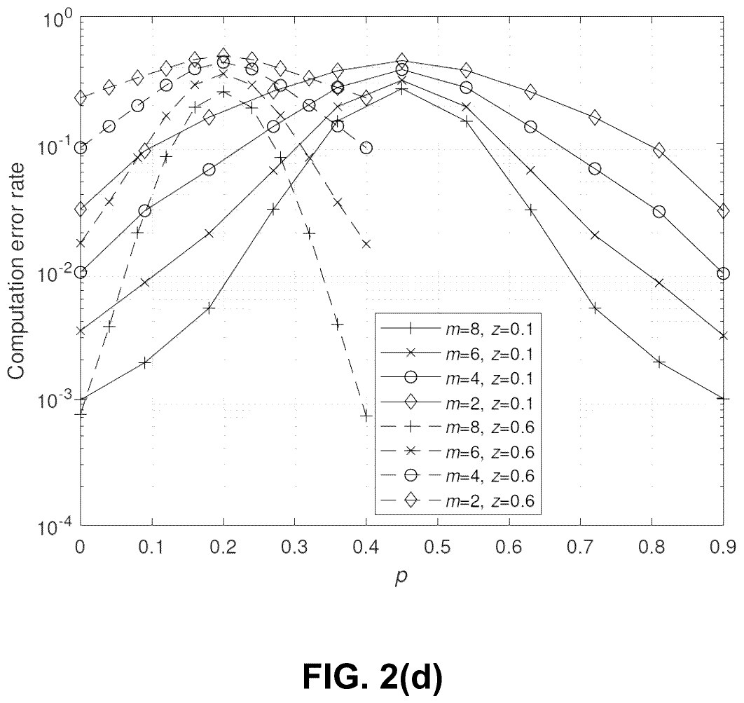

FIGS. 2(a) through 2(d) graphically provide the peak-to-mean envelope power ratio (PMEPR) distribution and the computation error rate (CER) for a given {p, q, z}, where p, q, and z denote the probabilities Pr (v_{k,n}>0), Pr (v_{k,n}<0), and Pr (v_{k,n}=0), respectively, for K=50 sensors, with specifically FIG. 2(a) graphically providing PMEPR distribution for m=8, p=0.1 and z∈{0.1, 0.3, 0.6}, and with specifically FIGS. 2(b), 2(c), and 2(d) graphically providing results of analyzing CER for z∈{0.1, 0.6} and m={2, 4, 6, 8} by sweeping p in additive white Gaussian noise (AWGN) (i.e., h_{k,i}=1)(FIG. 2(b), flat-fading (i.e., h_{k,i}=h_{k,i′}˜CN(0, 1) (FIG. 2(c), and frequency-selective (i.e., h_{k,i}˜CN(0, 1)) (FIG. 2(d)) channels, respectively.

Stated another way, FIGS. 2(a) through 2(d) graphically provide the computation error rate (CER) for in AWGN, flat-fading, and frequency-selective channels (K=50 sensors), and per peak-to-mean envelope power ratio (PMEPR) distribution. In particular, FIG. 2(a) illustrates PMEPR distribution (m=8), FIG. 2(b) illustrates CER in AWGN channel, FIG. 2(c) illustrates CER in flat-fading channel, and FIG. 2(d) illustrates CER in frequency-selective channel.

In FIG. 2(a), we show that the PMEPR of the disclosed methodology is always less than or equal to 3 dB due to the properties of the CSs. If there are no absentee votes, the maximum PMEPR of the disclosed methodology is 0 dB since a single subcarrier is used for the transmission. Hence, for a larger absentee vote probability, the probability of observing 0 dB PMEPR increases. The combination of sequences that lead to 0 dB and 3 dB PMEPR values result in the jumps in the PMEPR distribution given in FIG. 2(a).

In FIGS. 2(b) through 2(d), we analyze CER for z∈{0.1, 0.6} and m={2, 4, 6, 8} by sweeping p in AWGN (i.e., h_{k,i}=1), flat-fading (i.e., h_{k,i}=h_{k,i′}˜CN(0, 1)), and frequency-selective (i.e., h_{k,i}˜CN(0, 1)) channels, respectively. We observe that the disclosed methodology achieves a better CER for increasing m at the expense of more resource consumption in all channel conditions. The CER improves for a small or a large p since more sensors vote for −1 or +1, respectively. The performance in frequency selective channel is slightly better than the flat-fading channel because of the diversity gain.

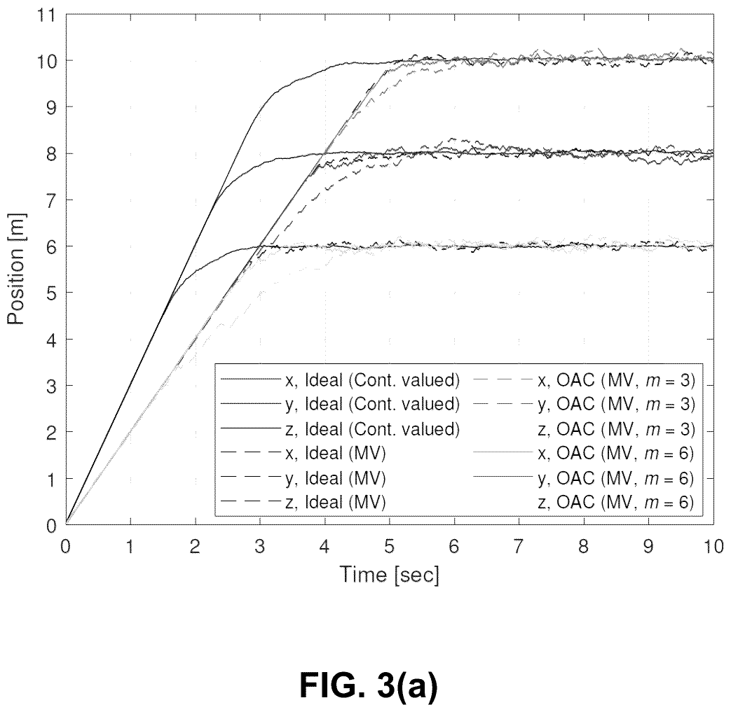

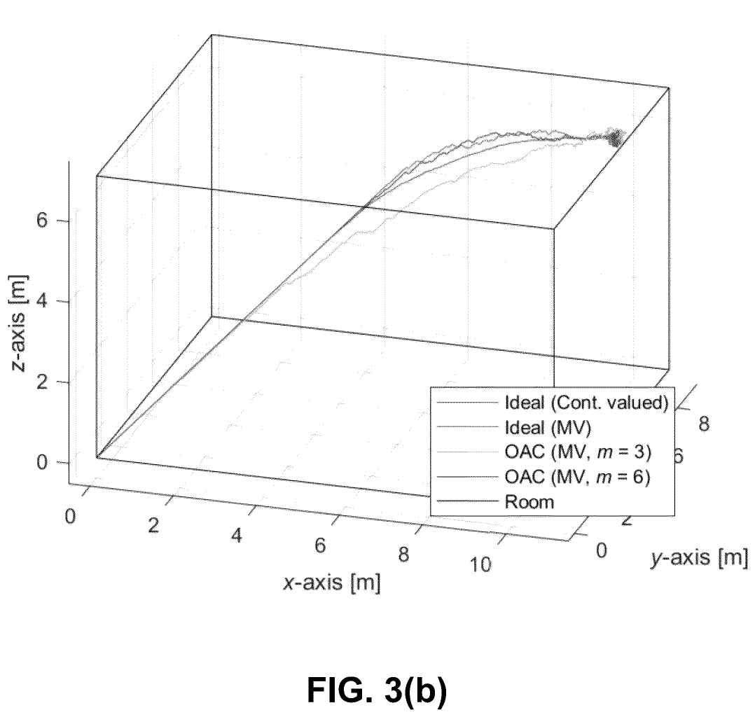

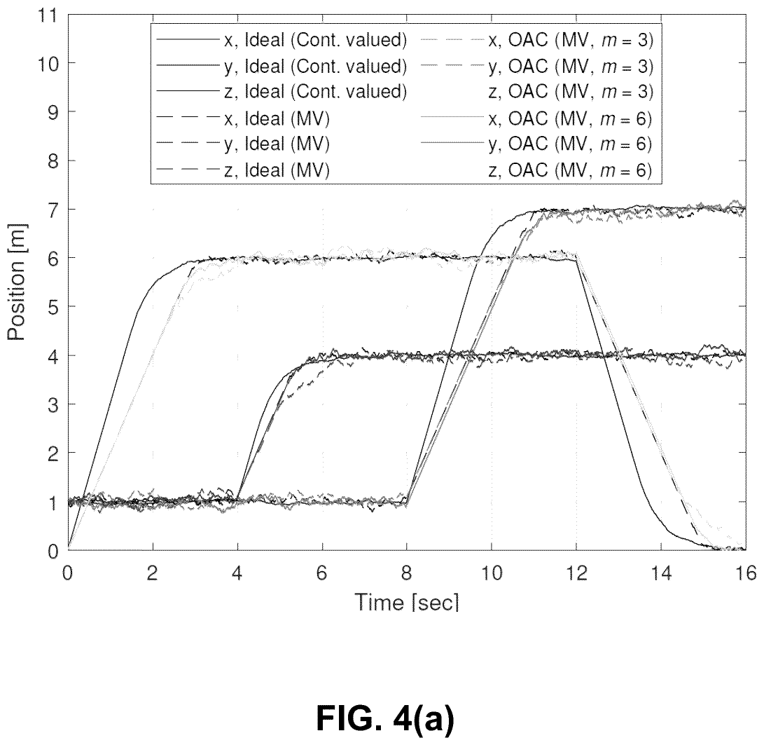

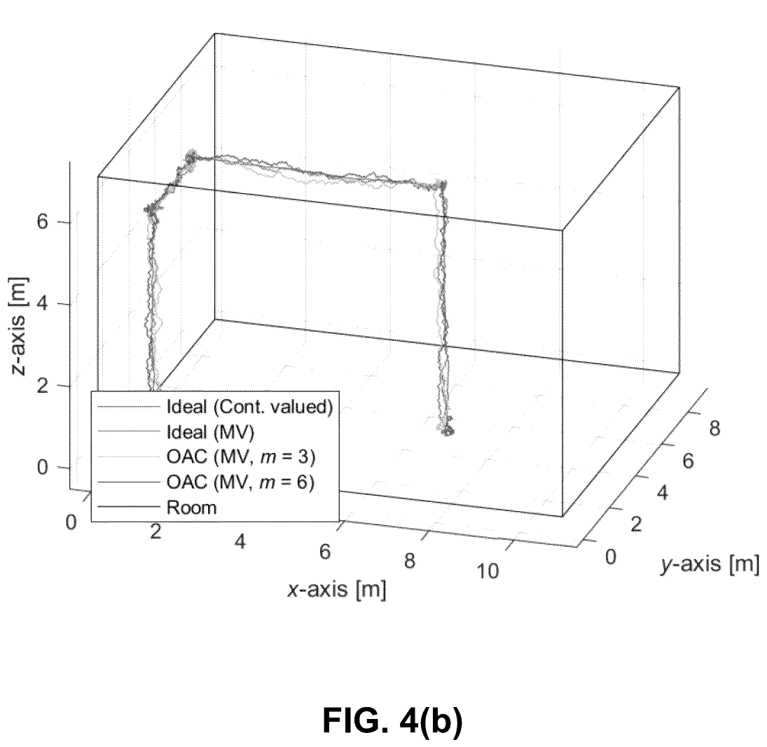

In FIGS. 3(a), 3(b) and FIGS. 4(a), 4(b), we consider the distributed UAV guidance scenario discussed in Section II for K=50 sensors.

In particular, FIGS. 3(a) and 3(b) graphically illustrate, respectively, an exemplary UAV's trajectory in time (FIG. 3(a)) and in space (FIG. 3(b)), based on a UAV's trajectory with a single point of interest, where the initial position is (pi,1, pi,2, pi,3)=(0, 0, 0) and the target is (pt,1, pt,2, pt,3)=(10, 8, 6). Further, FIGS. 4(a) and 4(b) graphically illustrate, respectively, an exemplary UAV's trajectory in time (FIG. 4(a)) and in space (FIG. 4(b)), based on a UAV's trajectory with multiple points of interest, where the initial position is (pi,1, pi,2, pi,3)=(1, 1, 0) and the multiple targets are (pt,1, pt,2, pt,3)=(1, 1, 6), (1, 4, 6), (7, 4, 6), and (7, 4, 0).

We assume T_{update}=10 ms, μ=2, uₗᵢₘᵢₜ=3 m/s, σₛₑₙₛₒᵣ ²=2, and SNR=10 dB. We provide the trajectory of the UAV in time and space for the aforementioned waypoint flight control scenario. We consider two cases. In the first case (FIGS. 3(a) and 3(b)), there is only one point of interest (p_{t,1}, p_{t,2}, p_{t,3})=(10, 8, 6) and the initial position of the UAV is (p_{i,1}, p_{i,2}, p_{i,3})=(0, 0, 0). In the second case (FIGS. 4(a) and 4(b)), the points of interest are (1, 1, 6), (1, 4, 6), (7, 4, 6), and (7, 4, 0), where the initial position of the UAV is (1, 1, 0). We compare the disclosed methodology for m ∈{3, 6} in a practical communication channel with both continuous and MV-based feedback in an ideal communication channel (i.e., no error due to the communications).

As can be seen from FIG. 3(a), for the continuous-valued feedback, the UAV reaches its position faster than any MV-based approach. This is because the velocity increment is limited with the step size for MV-based feedback in our setup. Hence, as can be seen from FIG. 3(b) the UAV's trajectory in space is slightly bent. Since the disclosed methodology is also based on the MV computation, its characteristics are similar to the one with MV computation in an ideal channel. Since the CER with m=6 is lower than the one with m=3, the result with the disclosed methodology for m=6 performs better and its characteristics are similar to the ideal MV-based feedback.

The position of the UAV in time and space for multiple points of interest is given in FIG. 4(a) and FIG. 4(b), respectively. Similar to the first scenario in FIGS. 3(a) and 3(b), the disclosed methodology for m=6 performs similarly to the one with the MVs in ideal communications and increasing m leads to a more stable trajectory.

In at least one exemplary aspect of some embodiments of this disclosure, we modulate the amplitude of the CS based on Theorem 1 to develop a new non-coherent OAC methodology for MV computation. We show that the disclosed methodology reduces the computation error rate via bandwidth expansion in both flat-fading and frequency-selective fading channel conditions while maintaining the PMEPR of the transmitted signals to be less than or equal to 3 dB. We demonstrate the applicability of the disclosed OAC methodology to an indoor distributed flight control scenario and show that the disclosed methodology performs similar to the case where MV without OAC with larger length of sequences. In the future work, we provide the theoretical computation error and convergence analyses for distributed UAV guidance.

This written description uses examples to disclose the presently disclosed subject matter, including the best mode, and also to enable any person skilled in the art to practice the presently disclosed subject matter, including making and using any devices or systems and performing any incorporated methods. The patentable scope of the presently disclosed subject matter is defined by the claims, and may include other examples that occur to those skilled in the art. Such other examples are intended to be within the scope of the claims if they include structural and/or step elements that do not differ from the literal language of the claims, or if they include equivalent structural and/or elements with insubstantial differences from the literal languages of the claims. In any event, while certain embodiments of the disclosed subject matter have been described using specific terms, such description is for illustrative purposes only, and it is to be understood that changes and variations may be made without departing from the spirit or scope of the subject matter. Also, for purposes of the present disclosure, the terms “a” or “an” entity or object refers to one or more of such entity or object. Accordingly, the terms “a”, “an”, “one or more,” and “at least one” can be used interchangeably herein.

### REFERENCES

[1] M. Goldenbaum, H. Boche, and S. Sta'nczak, “Nomographic functions: Efficient computation in clustered Gaussian sensor networks,” IEEE Trans. Wireless Commun., vol. 14, no. 4, pp. 2093-2105, 2015.
[2] A., Sahin and R. Yang, “A survey on over-the-air computation,” IEEE Communications Surveys & Tutorials, pp. 1-33, 2023.
[3] B. Nazer and M. Gastpar, “Computation over multiple-access channels,” IEEE Trans. Inf. Theory, vol. 53, no. 10, pp. 3498-3516 Oct. 2007.
[4] M. Goldenbaum, H. Boche, and S. Sta'nczak, “Harnessing interference for analog function computation in wireless sensor networks,” IEEE Trans. Signal Process., vol. 61, no. 20, pp. 4893-4906, 2013.
[5] M. Chen, D. Gündüz, K. Huang, W. Saad, M. Bennis, A. V. Feljan, and H. Vincent Poor, “Distributed learning in wireless networks: Recent progress and future challenges,” IEEE J. Sel. Areas Commun., pp. 1-26, 2021.
[6] A., Sahin, “Distributed learning over a wireless network with noncoherent majority vote computation,” IEEE Trans. Wireless Commun., pp. 1-16, 2023.
[7] G. Zhu, Y. Wang, and K. Huang, “Broadband analog aggregation for low-latency federated edge learning,” IEEE Trans. Wireless Commun., vol. 19, no. 1, pp. 491-506, Jan. 2020.
[8] G. Zhu, Y. Du, D. Gündüz, and K. Huang, “One-bit over-the-air aggregation for communication-efficient federated edge learning: Design and convergence analysis,” IEEE Trans. Wireless Commun., vol. 20, no. 3, pp. 2120-2135 Nov. 2021.
[9] B. McMahan, E. Moore, D. Ramage, S. Hampson, and B. A. y. Arcas, “Communication-Efficient Learning of Deep Networks from Decentralized Data,” in Proc. International Conference on Artificial Intelligence and Statistics (AISTATS), A. Singh and J. Zhu, Eds., vol. 54. PMLR, Apr. 2017, pp. 1273-1282.
[10] P. Park, P. Di Marco, and C. Fischione, “Optimized over-the-air computation for wireless control systems,” IEEE Commun. Lett., vol. 26, no. 2, pp. 1-5, 2022.
[11] S. Cai and V. K. N. Lau, “Modulation-free M2M communications for mission-critical applications,” IEEE Transactions on Signal and Information Processing over Networks, vol. 4, no. 2, pp. 248-263, 2018.
[12] J. Lee, Y. Jang, H. Kim, S.-L. Kim, and S.-W. Ko, “Over-the-air consensus for distributed vehicle platooning control (extended version),” 2022. [Online]. Available: https://arxiv.org/abs/2211.06225
[13] X. Zeng, X. Zhang, and F. Wang, “Optimized UAV trajectory and transceiver design for over-the-air computation systems,” IEEE Open Journal of the Computer Society, pp. 1-9, 2022.
[14] M. Fu, Y. Zhou, Y. Shi, C. Jiang, and W. Zhang, “UAV-assisted multi-cluster over-the-air computation,” IEEE Trans. Wireless Commun., pp. 1-1, 2022.
[15] M. M. Amiri and D. Gündüz, “Federated learning over wireless fading channels,” IEEE Trans. Wireless Commun., vol. 19, no. 5, pp. 3546-3557 Feb. 2020.
[16] H. Jung and S.-W. Ko, “Performance analysis of UAV-enabled over-the-air computation under imperfect channel estimation,” IEEE Wireless Commun. Lett., pp. 1-1, Nov. 2021.
[17] S. S. M. Hoque and A., Sahin, “Chirp-based majority vote computation for federated edge learning and distributed localization,” IEEE Open Journal of the Communications Society, pp. 1-1,2023.
[18] M. Goldenbaum and S. Stanczak, “Robust analog function computation via wireless multiple-access channels,” IEEE Trans. Commun., vol. 61, no. 9, pp. 3863-3877, 2013.
[19] A. ,Sahin and R. Yang, “A generic complementary sequence construction and associated encoder/decoder design,” IEEE Trans. Commun., pp. 1-15, 2021.
[20] J. A. Davis and J. Jedwab, “Peak-to-mean power control in OFDM, Golay complementary sequences, and Reed-Muller codes,” IEEE Trans. Inf. Theory, vol. 45, no. 7, pp. 2397-2417Nov. 1999.

What is claimed is:

1. An over-the-air computation (OAC) system for computation-oriented federated applications over wireless networks having a plurality of nodes, comprising:
one or more processors; and
one or more non-transitory computer-readable media that store instructions that, when executed by the one or more processors, cause the one or more processors to perform operations, the operations comprising:
transmitting local update vectors as votes from each respective of the plurality of nodes via a wireless multiple access channel,
receiving the superposed local updates at at least one of the plurality of nodes, and
determining the majority vote (MV) for each element of the update vector at the at least one node by non-coherent over-the-air computation (OAC) methodology to calculate the majority vote (MV) reliably in fading channels.

2. The over-the-air computation (OAC) system according to claim 1, wherein the non-coherent over-the-air computation (OAC) methodology is based on computations using complementary sequences (CSs).

3. The over-the-air computation (OAC) system according to claim 2, wherein the non-coherent over-the-air computation (OAC) methodology comprises modulating the amplitude of the elements of complementary sequences (CSs) based on the sign of the parameters to be aggregated.

4. The over-the-air computation (OAC) system according to claim 2, further comprising guiding an unmanned aerial vehicle (UAV) by distributed sensors based on the calculated majority vote (MV).

5. The over-the-air computation (OAC) system according to claim 1, further comprising conducting majority vote (MV) computation with complementary sequences for distributed UAV guidance.

6. The over-the-air computation (OAC) system according to claim 5, further comprising conducting majority vote computation to improve the computation error rate by using a longer sequence length in fading channels while maintaining the peak-to-mean-envelope power ratio of transmitted orthogonal frequency division multiplexing signals less than/equal to 3 dB.

7. The over-the-air computation (OAC) system according to claim 2, further comprising:
a sensor provided at each node; and
wherein conducting majority vote computation includes modulating the amplitude of the elements of each CS via fᵣ(x) as a function of the votes vₖ≙(v_{k,1}, . . . , v_{k,m}) at the kth sensor.

8. The over-the-air computation (OAC) system according to claim 7, wherein one half of the elements of each CS are set to zero and the other half are scaled by a predetermined factor.

9. The over-the-air computation (OAC) system according to claim 8, wherein the sign of each element of each CS determines whether half of an element is scaled or set to zero.

10. The over-the-air computation (OAC) system according to claim 9, wherein the OAC system further comprises:
a distributed machine-learning model to be trained with the update vectors received from the plurality of nodes; and
wherein the operations further comprise calculating the MVs without using channel state information (CSI) at the plurality of nodes, and inputting the calculated MVs into the machine-learning model to be updated.

11. The over-the-air computation (OAC) system according to claim 1, wherein the OAC system comprises at least one of a wireless federated learning system, a wireless control system, a distributed control system, and an artificial intelligence system implemented over wireless or sensor networks.

12. An over-the-air computation (OAC) methodology for use on computation-oriented federated applications over wireless networks having a plurality of nodes, comprising:
providing one or more processors; and
providing one or more non-transitory computer-readable media that store instructions that, when executed by the one or more processors, cause the one or more processors to perform operations, the operations comprising:
transmitting local update vectors as votes from each respective of the plurality of nodes via a wireless multiple access channel,
receiving the superposed local updates at at least one of the plurality of nodes, and
determining the majority vote (MV) for each element of the update vector at the at least one node by non-coherent over-the-air computation (OAC) methodology to calculate the majority vote (MV) reliably in fading channels.

13. The over-the-air computation (OAC) methodology according to claim 12, wherein the non-coherent over-the-air computation (OAC) methodology is based on computations using complementary sequences (CSs).

14. The over-the-air computation (OAC) methodology according to claim 13, wherein the non-coherent over-the-air computation (OAC) methodology comprises modulating the amplitude of the elements of complementary sequences (CSs) based on the sign of the parameters to be aggregated.

15. The over-the-air computation (OAC) methodology according to claim 13, further comprising guiding an unmanned aerial vehicle (UAV) by distributed sensors based on the calculated majority vote (MV).

16. The over-the-air computation (OAC) methodology according to claim 12, further comprising conducting majority vote (MV) computation with complementary sequences for distributed UAV guidance.

17. The over-the-air computation (OAC) methodology according to claim 16, further comprising conducting majority vote computation to improve the computation error rate by using a longer sequence length in fading channels while maintaining the peak-to-mean-envelope power ratio of transmitted orthogonal frequency division multiplexing signals less than/equal to 3 dB.

18. The over-the-air computation (OAC) methodology according to claim 13, further comprising:
providing a sensor at each node; and
wherein conducting majority vote computation includes modulating the amplitude of the elements of each CS via fᵣ(x) as a function of the votes vₖ≙(v_{k,1}, . . . , v_{k,m}) at the kth sensor.

19. The over-the-air computation (OAC) methodology according to claim 18, wherein one half of the elements of each CS are set to zero and the other half are scaled by a predetermined factor.

20. The over-the-air computation (OAC) methodology according to claim 19, wherein the sign of each element of each CS determines whether half of an element is scaled or set to zero.

21. The over-the-air computation (OAC) methodology according to claim 20, further comprising:
providing a distributed machine-learning model to be trained with the update vectors received from the plurality of nodes; and
wherein the operations further comprise calculating the MVs without using channel state information (CSI) at the plurality of nodes, and inputting the calculated MVs into the machine-learning model to be updated.
